(19) United States
(12) Patent Application Publication
(10) Pub. No.: US 2022/0388184 A1
(43) Pub. Date: Dec. 8, 2022

(54) APPARATUS FOR HOLDING CABLES OF ROBOT AND ASSOCIATED ROBOT

(71) Applicant: ABB Schweiz AG, Baden (CH)

(72) Inventors: Jiajie Sha, Shanghai (CN); Xiaodong Cao, Shanghai (CN); Yun Ha, Shanghai (CN); Yinong Chen, Shanghai (CN)

(21) Appl. No.: 17/755,265

(22) PCT Filed: Oct. 29, 2019
(86) PCT No.: PCT/CN2019/113953

§ 371 Date: Apr. 25, 2022

(51) Int. Cl. B25J 19/00; H02G 3/04

(52) U.S. Cl. CPC B25J 19/0025; H02G 3/0456

(57) ABSTRACT

Present disclosure provide an apparatus for holding cables of a robot and a robot. The apparatus comprises a body extending along an axis and comprising a circumferential wall to space the cables arranged in the body from a first part of the robot; and a slit formed on the circumferential wall across an entire length of the circumferential wall along the axis, the slit adapted for the cable to pass through radially to allow the cables to be arranged in the body. With the slit formed across the entire length of the circumferential wall along the axis, the cables can be easily arranged in the body radially through the slit. In this way, the cables can be arranged in the apparatus without having to remove the large connector, thereby improving assembly efficiency. In addition, since the connector does not need to be removed, the connection performance is also improved.

### FIELD

Embodiments of the present disclosure generally relate to a robot, and more specifically, to an apparatus for holding cables for a robot and the associated robot.

### BACKGROUND

Robots including industrial robots are widely used for manufacturing. Industrial robots are automated, programmable and capable of movement on three or more axis. A robot usually has one or more driver or drive unit to drive end effectors and/or arm links to perform certain actions. Examples of the drive unit include, but are not limited to, motors, hydraulic pumps, pneumatic pumps or the like. The end effectors and/or arm links, drive unit and the control unit of the robot are usually connected by cables such as power cables, air pipes, oil pipes, and so on.

Cables are usually arranged in arm links of the robot and the arm links typically rotate around a joint. As a result, it is desired that the cables are routed in such a way that the cables do not affect rotation ranges of the robot arm links. Nowadays, the cables are typically held in the arm links by an apparatus of a cylindered shape. In this way, the cables, especially a portion of which adjacent to or surrounded by a high-speed part, can be isolated from the high-speed part to avoid possible abrasion.

To connect the various parts of the robot through the cables, connectors are typically arranged on one or two ends of each cable. However, the connectors, each typically having a larger size than a diameter of the apparatus, are not easy to pass through when arranging the cables in the apparatus.

### SUMMARY

Embodiments of the present disclosure provide an apparatus for holding cables of a robot and an associated robot.

In a first aspect, an apparatus for holding at least one cable of a robot is provided. The apparatus comprises a body extending in an axial direction and comprising a circumferential wall to space the at least one cable arranged in the body from a first part of the robot; and a slit formed on the circumferential wall in the axial direction, the slit adapted to allow the at least one cable to pass through so that the at least one cable is arranged in the body.

With the slit formed across the entire length of the circumferential wall along the axis, the cables can be easily arranged in the body radially through the slit. In this way, the cables can be arranged in the apparatus without having to remove the large connector, thereby improving assembly efficiency. In addition, since the connector does not need to be removed, the connection performance is also improved.

In some embodiments, the slit is of a helical shape around an axis of the body. The helical shape of the slit can prevent from accidentally coming out, improving the reliability of the robot.

In some embodiments, the slit is of a straight or curve line shape extending on one side of an axis in the axial direction. In this way, the apparatus can be made in a cost-efficient way.

In some embodiments, a width of the slit is smaller than a diameter of a thinnest of the at least one cable, and the circumferential wall is deformable to allow the slit to be expanded in a width direction. As a result, the apparatus can be easily manufactured while preventing from the cables from accidentally coming out, thereby improving the reliability of the robot in a cost-efficient way.

In some embodiments, the apparatus further comprises a further slit arranged radially opposite to the slit to divide the circumferential wall into two half shells, and the two half shells are coupled with each other at the slit and the further slit to form the body. With this arrangement, the cables can be arranged in the body more easily.

In some embodiments, the apparatus further comprises a flange fixedly arranged at an end of the body and adapted to be fixed to a second part of the robot which rotates relative to the first part. As a result, the apparatus can be easily fixed to the second part of the robot, thereby improving the assembly efficiency.

In some embodiments, the flange comprises a flange slit extending across an entire radius of the flange at a location aligned with the slit. In this way, the flange would not hinder the arrangement of the cables while improving the assembly efficiency.

In some embodiments, the body and the flange are integrally formed. This arrangement can improve the strength of the apparatus.

In some embodiments, the apparatus further comprises a circular arc transition at a corner between the flange and the circumferential wall. In this way, the cables arranged in the body can be protected from being damaged by sharp corners, improving the reliability.

In a second aspect, a method of manufacturing an apparatus for holding at least one cable of a robot is provided. The method comprises providing a body extending in an axis direction and comprising a circumferential wall to isolate the at least one cable arranged in the body from a first part of the robot; and forming a slit on the circumferential wall in the axial direction, the slit adapted to allow the at least one cable to pass through so that the at least one cable is arranged in the body.

In a third aspect, a robot is provided. The robot comprises an apparatus as mentioned in the above first aspect.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent same components.

FIGS. 1A-1C show an apparatus as used in prior art;

FIG. 2 shows a side view of an apparatus for holding cable of a robot which is arranged in the parts of the robot according to embodiments of the present disclosure;

FIG. 3 shows a perspective view of an apparatus for holding cables according to embodiments of the present disclosure;

FIG. 4 shows a perspective view of an apparatus for holding cables with one cable being arranged therein according to embodiments of the present disclosure;

FIG. 5 shows a perspective view of an apparatus for holding cables according to further embodiments of the present disclosure;

FIG. 6 shows a perspective view of an apparatus for holding cables according to yet further embodiments of the present disclosure; and

FIG. 7 shows a flowchart illustrating a manufacturing method of an apparatus for holding cables of a robot according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

Cables 201, which are usually arranged in arm links of the robot, are key components working in robots, especially in industrial robots. Cables, comprising power cables, air pipes, oil pipes, or the like, are typically used to transmit data between end effectors, drive units and control units, and to deliver high pressure gas, liquid between the drive units and the hydraulic or pneumatic source, for example. To connect the above mentioned parts, connectors are typically arranged on one or two ends of each cable.

The cables 201 are usually routed in the arm links by passing through the moving parts of the robot. Because the arm links of the robot typically rotate around a joint, how to route the cable to prevent the cable from affecting rotation range of the robot arm link and prevent premature failure of the cable is a challenge in robot design.

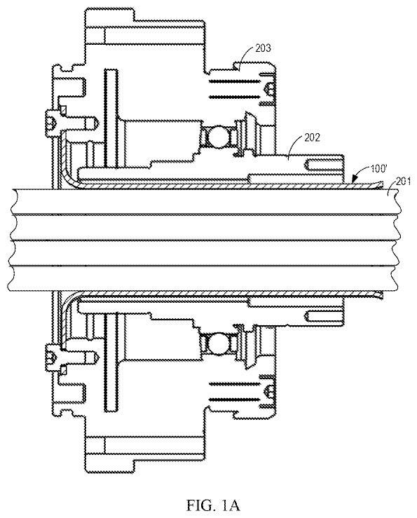

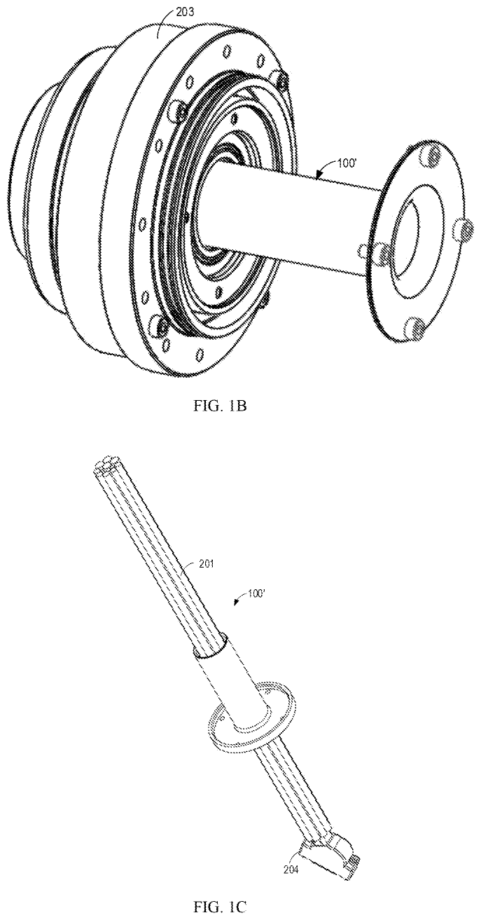

FIGS. 1A-1C show an example to illustrate how cables are routed in the moving parts 202, 203 of the robots in the prior art. The two parts (referred to as a first part 202, and a second part 203 for ease of discussion hereinafter) as shown in FIGS. 1A and 1B are common structures typically arranged in a joint of the robot. The first part 202 is typically a high-speed rotating part that is coupled to a drive unit, such as a motor or the like. The second part 203 is typically a low-speed rotating part that is coupled to, for example, an arm link or an end effector.

There is typically a gearbox, for example arranged between the first and second parts 202, 203, to allow transmission of motion. As shown, cables 201 are needed to pass through the first and second parts 202, 203, especially the first part 202, which is a high-speed part, for example. As a result, there is a risk that the cables would contact the first component and be worn by it if the cables are not isolated from the first and second parts 202, 203.

Nowadays, an apparatus for holding the cables 201 is typically used to isolate the cables 201 from the rotating parts. As shown in FIG. 1C, the apparatus 100′ is of a cylindered shape, which can receive the cables 201 along its axis. To reduce the occupied space to facilitate the miniaturization of the robot, the apparatus 100′ is typically sized to allow a required number of cables to be placed therein.

The problem that comes with it is that the connectors 204, each typically having a larger size than a diameter of the apparatus 100′, are not easy to pass through when arranging the cables 201 in the apparatus 100′. In addition, even though some connectors 204 can pass the apparatus 100′ when the apparatus 100′ is empty or has few cables, as the number of cables that are inserted increases, the space inside the apparatus 100′ becomes smaller and smaller. This makes it increasingly difficult to arrange the cables 201 into the apparatus 100′.

One of the conventional solutions is to disassemble the connectors 204 from the cables before the arrangement of cables 100 in the apparatus 100′. After the cables 201 are arranged in the apparatus 100′, the connectors 204 are reconnected to the cables 201.

As well known, for the reliability of the connection, the connector 204 is preferably connected to the cable initially. Disassembly or reconnection would result in reduced reliability. Therefore, the conventional apparatus 100′ for holding the cables 201 would bring about problems such as reduced reliability and cumbersome assembly process.

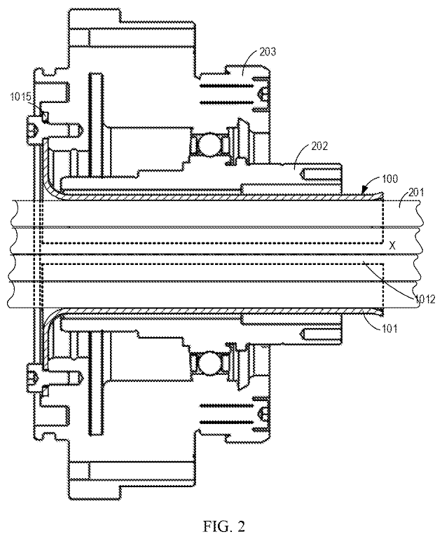

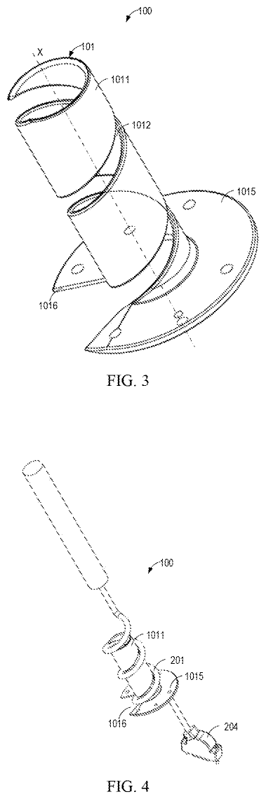

In order to address or at least partially address the above and other potential problems, embodiments of the present disclosure provide an apparatus 100 for holding cables 201 of a robot. FIG. 2 shows a side view of the apparatus 100 and FIG. 3 shows a perspective view of the apparatus.

As shown, the apparatus 100 as a whole is of a cylindered shape extending along an axis X, i.e., in an axial direction. A body 101 of the apparatus 100 has a circular cross section, so that more cables can be received with the same cross-sectional area compared to the cylinder with other shapes in cross section, such as square, or the like. Of course, in some alternative embodiments, the body 101 may also have a square, rectangle or oven cross section, or the like.

The body 101 comprises a circumferential wall 1011 to isolate at least one cable 201 arranged in the body 101 from the first part 202 of the robot. In this way, the circumferential wall 100 can protect the at least one cable 201 from contacting the first part 202 and from being worn. Hereinafter, the idea of the present disclosure will be described by taking a plurality of cables arranged in the body 101 as an example.

Different from the conventional apparatus 100′ as shown in FIGS. 1A-1C, the apparatus 100 according to embodiments of the present disclosure comprises a slit 1012 formed on the circumferential wall 101, as shown in FIGS. 2 and 3. The slit 1012 extends in an axis direction to allow the cables 201 to pass through. That is, the slit 1012 extends from one end to another end of the circumferential wall 1011 in the axial direction.

In this way, the cables 201 with large connector 204 can be arranged in the body 101 by inserting a section of each cable 201 radially through the slit 1012. That is, with the slit 1012 formed across the entire length of the circumferential wall 1011 along the axis X, the cables 201 can be easily arranged in the body 101 by radially passing through the slit 1012. In this way, the cables 201 can be arranged in the apparatus 100 without having to remove the large connector 204, thereby improving assembly efficiency. In addition, since the connector 204 does not need to be removed, the connection performance is also improved.

Furthermore, in some embodiments, the slit 1012 may be formed by the removal of some of the material on the circumferential wall 1011. In this way, the apparatus 100 according to embodiments of the present disclosure is less heavy than conventional apparatus 100′. In some alternative embodiments, the slit 1012 may also be formed by winding a metal strip. In this way, by winding the metal strip around a shaft, which has a diameter equal to an inner diameter of the body 101 to be formed, the body 101 can be formed with a slit being of a helical shape, as shown in FIG. 3.

The helical shape of the slit 1012 around the axis X can efficiently prevent the cables 201 which have been arranged in the body 101 from accidentally coming out, improving the reliability of the cable routing and even the robot.

Specifically, as shown in FIG. 4, when arranging the cable 201 in the body 101, it is only necessary to twist the cables 201 to a helical shape aligned with the slit 1012. Then the cable 201 is pushed radially towards the axis X until most of the helical portion of the cable 201 is arranged in the body 101. After that, the helical portion of the cable 201 is straightened and is then reliably placed in the body 101.

It can be seen that with the slit 1012 formed on the circumferential wall 1011, the cable 201 can be arranged in the body 101 without disassembly and reconnection of the connector 204. Assembly efficiency and reliability of the connection can thus be improved.

A pitch of the helical shape of the slit 1012 may be appropriately selected as needed. For example, as shown in FIG. 3, the pitch of the helical shape of the slit 1012 may be half of the entire length of the body 101, which can effectively prevent the cables 201 from accidentally coming out while effectively reducing the cost. Of course, it is also possible that the pitch is other values, such as ⅓, 1.5, or 2 times the entire length of the body 101.

It is to be understood that the above embodiments where the slit 1012 has a helical shape are merely for illustrative, without suggesting any limitation as to the scope of the present disclosure. The slit 1012 may be of any other suitable shapes, as long as it can allow each cable to pass through radially. For example, in some embodiments, as shown in FIGS. 2, 5 and 6, the slit 1012 may also be a straight line extending along the axis X.

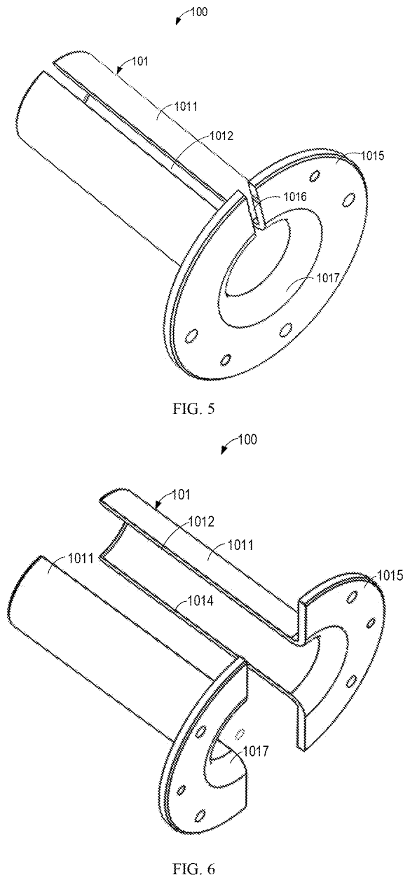

For example, as shown in FIG. 5, the slit 1012 may be of a straight line formed on the circumferential wall 1011. To prevent the cables 201 that have been arranged in the body 101 from accidentally coming out, a width of the slit 1012 may be smaller than a diameter of a thinnest of the cables 201. Furthermore, the circumferential wall 1011 may be deformable.

In this way, when arranging the cables 201 in the body 201, the circumferential wall may be slightly deformed to allow each cable 201 to be arranged in the body 101. Due to the smaller width of the slit 1012, the cables 201 arranged in the body 101 are free of accidentally coming out and contacting the first part 202, thereby improving the reliability of the robot in a cost-efficient way.

In addition to or instead of the smaller width of the slit 1012, other structures to prevent the cables from coming out are also possible. For example, in some alternative embodiments, there are some deformable protrusions with for example teeth shape arranged along the slit 1012. The deformable protrusions would not hinder the insertion of the cables 201 while preventing the cables 201 arranged in the body 101 from accidentally coming out.

It is to be understood that the above embodiments where the slit 1012 is of a straight line shape are merely for illustrative, without suggesting any limitation as to the scope of the present disclosure. Other shapes or structures are possible as well. For example, in some alternative embodiments, the slit 1012 may also be of a curve line extending in the axis direction on one side of the axis X.

In some alternative embodiments, as shown in FIG. 6, besides the slit 1012 as mentioned above, the apparatus 100 further comprises a further slit 1014 arranged opposite to the slit 1012 relative to the axis X. The two slits 1012, 1014 can divide the circumferential wall 1011 into two half shells. The two half shells can be fixed in a suitable way at the two slits 1012, 1014 to form the body 101.

As a result, the cables 201 can be arranged in the body 101 more easily. When the two half shells are assembled into the body 101, it is only necessary to arrange all the bundled cables disposed between the two half shells in one time. The two half shells can be coupled with each other by snap connections, magnet connections, screw connections or the like for example.

For instance, in some embodiments, there are several projects along a slit wall of one half shell and several corresponding recesses, for receiving and locking the projects, formed on a corresponding slit wall of another half shell. In this way, the two half shells can be coupled with each other by pushing the projects into the recess, thereby further improving the assembly efficiency.

To facilitate the mounting of the apparatus 100 to the robot, in some embodiments, the apparatus may further comprise a flange 1015 fixedly arranged at an end of the body 101, as shown in FIGS. 3-6. With the flange 1015, the apparatus 100 can be easily fixed to the second part 203 for example.

In some embodiments, there is a flange slit 1016 formed on the flange 1015 and extending across an entire radius of the flange 1015 at a location aligned with the slit 1012, as shown in FIGS. 3-6. The flange slit 1016 allows the cables 201 to be arranged in the body 101 with the flange 1015.

In some embodiments, as shown in FIG. 3, the flange slit 1016 may be of a sector shape, which facilitates the insertion of the cables 201 into the body 101. In some alternative embodiments, the flange slit 1016 may also be of a strip shape, as shown in FIG. 5, which allows the apparatus 100 to be manufactured more easily.

To enhance the strength of the apparatus, in some embodiments, the flange 1015 and the body 101 may be integrally formed. The integrally formed apparatus 100 may be manufactured in any suitable ways, for example by stamping, molding or the like. It is to be understood that the above embodiments where the apparatus 100 is integrally formed are merely for illustrative, without suggesting any limitation as to the scope of the present disclosure. In some alternative embodiments, the flange 1015 may also be assembled to the body 101 after being manufactured separately.

Furthermore, the apparatus 100 may be formed of any suitable materials, for example, steel, plastic or composite material. The apparatus 100 made of plastic or composite materials can further reduce the weight of the robot.

In some embodiments, there may be a circular arc transition formed at a corner between the flange 1015 and the circumferential wall 1011, as shown in FIG. 5. The transition 1017 allows the cables 201 arranged in the body 101 to be protected from being damaged by sharp corners, improving the reliability.

Embodiments of the present disclosure further provide a robot comprising an apparatus as mentioned above. With the apparatus 100 for holding the cables 201, the assembly efficiency and reliability of the robot can be improved.

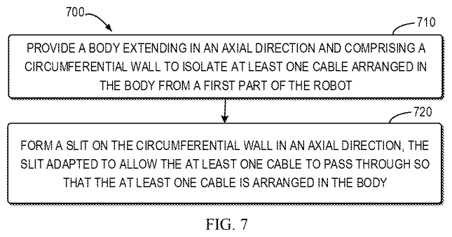

Embodiments of the present disclosure further provide a manufacturing method of the above mentioned apparatus 100. FIG. 7 shows a flowchart 700 illustrating a manufacturing method of the apparatus 100. As shown, in block 710, a body 101 extending along an axis is provided. The body 101 comprises a circumferential wall 1011 to isolate the cables 201 arranged in the body 101 from a first part 202 of the robot.

In block 720, a slit 1012 is formed on the circumferential wall 1011 across an entire length of the circumferential wall 1011 along the axis. The cables 201 can be arranged in the body 101 by passing through the slit 1012 radially. The slit 1012 may be formed by removing the material from the body 101 or by winding a strip.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. An apparatus for holding at least one cable of a robot, comprising:
a body extending in an axial direction and comprising a circumferential wall to isolate the at least one cable arranged in the body from a first part of the robot; and
a slit formed on the circumferential wall in the axial direction, the slit adapted to allow the at least one cable to pass through so that the at least one cable is arranged in the body.

2. The apparatus of claim 1, wherein the slit is of a helical shape around an axis (X) of the body.

3. The apparatus of claim 1, wherein the slit is of a straight or curve line shape extending on one side of an axis (X) in the axial direction.

4. The apparatus of claim 3, wherein a width of the slit is smaller than a diameter of a thinnest of the at least one cable, and the circumferential wall is deformable to allow the slit to be expanded in a width direction.

5. The apparatus of claim 3, further comprising a further slit arranged radially opposite to the slit to divide the circumferential wall into two half shells, and the two half shells are coupled with each other at the slit and the further slit to form the body.

6. The apparatus of claim 1, further comprising a flange fixedly arranged at an end of the body and adapted to be fixed to a second part of the robot which rotates relative to the first part.

7. The apparatus of claim 6, wherein the flange comprises a flange slit extending across an entire radius of the flange at a location aligned with the slit.

8. The apparatus of claim 6, wherein the body and the flange are integrally formed.

9. The apparatus of claim 1, further comprising a circular arc transition at a corner between the flange and the circumferential wall.

10. A method of manufacturing an apparatus for holding at least one cable of a robot, comprising:
providing a body extending in an axial direction and comprising a circumferential wall to isolate the at least one cable arranged in the body from a first part of the robot; and
forming a slit on the circumferential wall in the axial direction, the slit adapted to allow the at least one the cable to pass through so that the at least one cable is arranged in the body.

11. A robot comprising the apparatus of claim 1.

12. A robot comprising the apparatus of claim 2.

13. A robot comprising the apparatus of claim 3.

14. A robot comprising the apparatus of claim 4.

15. A robot comprising the apparatus of claim 5.

16. A robot comprising the apparatus of claim 6.

17. A robot comprising the apparatus of claim 7.

18. A robot comprising the apparatus of claim 8.

19. A robot comprising the apparatus of claim 9.
